(19) United States
(12) Patent Application Publication
(10) Pub. No.: US 2019/0364230 A1
(43) Pub. Date: Nov. 28, 2019

(54) METHOD OF PROCESSING DATA FOR DYNAMIC VISION SENSOR, DYNAMIC VISION SENSOR PERFORMING THE SAME AND ELECTRONIC DEVICE INCLUDING THE SAME

(71) Applicant: Samsung Electronics Co., Ltd., Suwon-si (KR)

(72) Inventors: Dong-Hee YEO, Seoul (KR); Hyun-Surk RYU, Hwaseong-si (KR); Keun-Joo PARK, Seoul (KR); Hyun-Ku LEE, Suwon-si (KR); Hee-Jae JUNG, Suwon-si (KR)

(73) Assignee: Samsung Electronics Co., Ltd., Suwon-si (KR)

(21) Appl. No.: 16/241,113

(22) Filed: Jan. 7, 2019

(30) Foreign Application Priority Data
May 23, 2018 (KR) 10-2018-0058445

(51) Int. Cl. H04N 5/341; H04N 5/355; H04N 5/369

(52) U.S. Cl. CPC H04N 5/341; H04N 5/3698; H04N 5/355

(57) ABSTRACT

In a method of processing data for a dynamic vision sensor, changes of light are detected by the dynamic vision sensor to output a plurality of event frames. A data format conversion is performed to convert the plurality of event frames into at least one image frame. An image compression is performed to compress the at least one image frame.

### CROSS-REFERENCE TO RELATED APPLICATION

This U.S. non-provisional application claims the benefit of priority under 35 USC § 119 to Korean Patent Application No. 10-2018-0058445, filed on May 23, 2018 in the Korean Intellectual Property Office (KIPO), the contents of which are herein incorporated by reference in their entirety.

### BACKGROUND

### 1. Technical Field

Various example embodiments relate generally to vision sensors, and more particularly to methods of processing data for dynamic vision sensors, dynamic vision sensors performing the methods, electronic systems including the dynamic vision sensors, and/or non-transitory computer readable media storing computer readable instructions for implementing the methods.

### 2. Description of the Related Art

A conventional vision sensor captures a scene (e.g., an image scene) as a sequence of pictures or frames that are taken at a certain rate (e.g., a frame rate), where every picture element (e.g., pixel) within the boundary of a frame is captured in the frame. Pixel information that does not change from one frame to another frame is considered redundant information. Storing and processing redundant information wastes storage space, processing time, and battery power.

A dynamic vision sensor (DVS) does not capture a scene in frames like conventional image sensors, but instead functions similarly to a human retina. That is, a dynamic vision sensor transmits only a change in a pixel's luminance (e.g., an event) at a particular location within a scene at the time of the event.

An output of a dynamic vision sensor is a stream (e.g., a datastream) of events, where each event is associated with a particular state, e.g., a location of the event within a camera array and a binary state indicating a positive or a negative change in the luminance of the associated event as compared to an immediately preceding state of the associated location.

### SUMMARY

At least one example embodiment of the inventive concepts provides a method of processing data capable of efficiently storing data output from a dynamic vision sensor.

At least one example embodiment of the inventive concepts provides a dynamic vision sensor apparatus performing the method of processing data.

At least one example embodiment of the inventive concepts provides an electronic device including the dynamic vision sensor.

According to one or more example embodiments, a method of processing data for a dynamic vision sensor may include detecting, using at least one processor, changes of light sensed by a dynamic vision sensor, outputting, using the at least one processor, a plurality of event frames from the dynamic vision sensor based on the detected changes of light, converting, using the at least one processor, the plurality of event frames into at least one image frame, and compressing, using the at least one processor, the at least one image frame.

According to one or more example embodiments, a dynamic vision sensor may include a pixel array including a plurality of pixels, the pixel array configured to detect changes of light to output a plurality of event frames, and an image processor configured to convert the plurality of event frames into at least one image frame, and compress the at least one image frame.

According to one or more example embodiments, an electronic device may include a dynamic vision sensor configured to detect changes of light, and output a plurality of event frames based on the detected changes of light, and at least one processor configured to convert the plurality of event frames into at least one image frame, and compress the at least one image frame.

In the method of processing data according to one or more example embodiments and the dynamic vision sensor according to one or more example embodiments, the event frames output from the dynamic vision sensor may be converted into the image frame having a general and/or a typical image format, the image frame may be compressed to obtain the compressed image frame, and the compressed image frame may be stored. In other words, the compressed image frame having a relatively small amount of data may be stored as the output of the dynamic vision sensor rather than storing the event frames having a relatively large amount of data. Accordingly, data corresponding to the event frames may be efficiently stored into a limited, reduced and/or confined storage space even if the number of events (e.g., the number of the event frames) increases, and the dynamic vision sensor may have the improved and/or enhanced performance even if a relatively low speed data interface is employed with the dynamic vision sensor.

For example, the data format conversion may be performed based on one of various schemes where there is a one-to-one correspondence between all of the event pixel data and all of the bits of the image pixel data (e.g., a scheme where the event pixel data are time-sequentially assigned to the bits of the image pixel data, a scheme where the event pixel data are assigned to the bits of the image pixel data according to the pixel locations, etc.).

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of processing data for a dynamic vision sensor according to one or more example embodiments.

FIG. 2 is a diagram for describing a method of processing data for a dynamic vision sensor according to one or more example embodiments.

FIG. 3 is a block diagram illustrating a dynamic vision sensor according to one or more example embodiments.

FIG. 4 is a circuit diagram illustrating an example of a pixel included in a dynamic vision sensor according to one or more example embodiments.

FIG. 5 is a block diagram illustrating an electronic device including a dynamic vision sensor according to one or more example embodiments.

FIGS. 6, 7 and 8 are diagrams for describing a method of processing data for a dynamic vision sensor according to one or more example embodiments.

FIGS. 9 and 10 are flow charts illustrating a method of processing data for a dynamic vision sensor according to one or more example embodiments.

FIG. 11 is a block diagram illustrating an electronic system including a dynamic vision sensor according to one or more example embodiments.

### DETAILED DESCRIPTION

Various example embodiments will be described more fully with reference to the accompanying drawings, in which example embodiments are shown. The inventive concepts may, however, be embodied in many different forms and should not be construed as limited to the example embodiments set forth herein. Like reference numerals refer to like elements throughout this application.

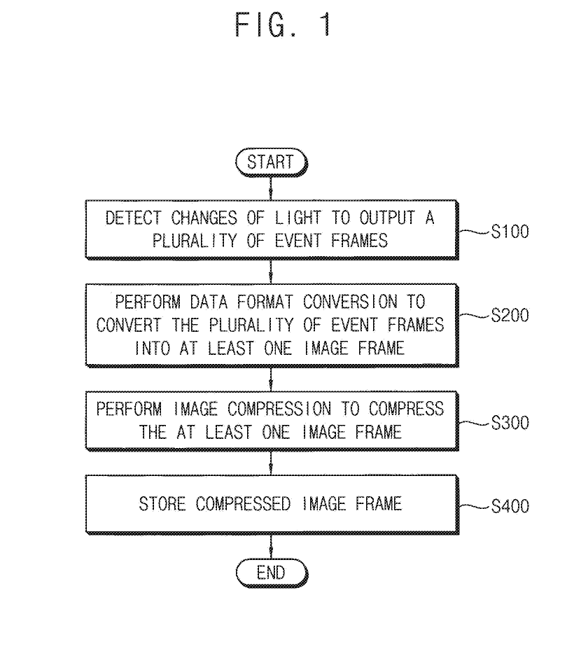

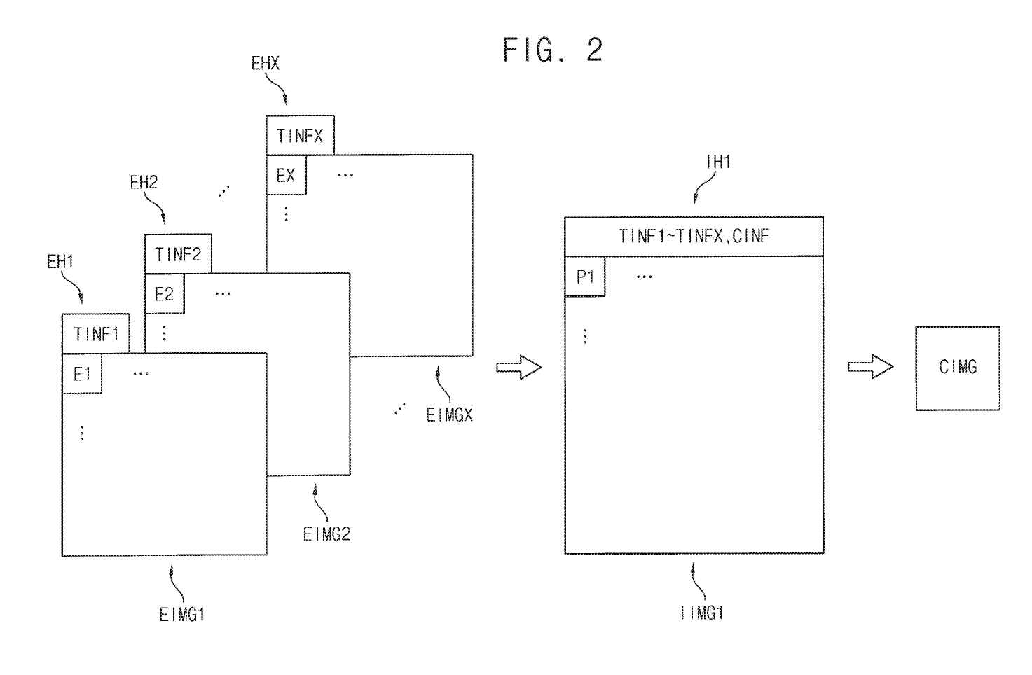

FIG. 1 is a flow chart illustrating a method of processing data for a dynamic vision sensor according to one or more example embodiments. FIG. 2 is a diagram for describing a method of processing data for a dynamic vision sensor according to one or more example embodiments.

Referring to FIGS. 1 and 2, in a method of processing data for a dynamic vision sensor (DVS) according to at least one example embodiment, the dynamic vision sensor detects changes of light to output a plurality of event frames (step S100). The plurality of event frames may have a data format of (e.g., a data format corresponding to) the dynamic vision sensor. Each event frame may include a plurality of event pixel data, and each event pixel data may include one-bit data, but the example embodiments are not limited thereto. For example, the event pixel data may be two-bits or greater.

For example, as illustrated in FIG. 2, the plurality of event frames may include first through X-th event frames EIMG1, EIMG2, . . . , EIMGX, where X is a natural number greater than or equal to two. For example, the first event frame EIMG1 may include first event pixel data E1 which is, for example, one-bit data, the second event frame EIMG2 may include second event pixel data E2 which is, for example, one-bit data, and the X-th event frame EIMGX may include X-th event pixel data EX which is, for example, one-bit data. Although not illustrated in detail in FIG. 2, each event frame may include Y event pixel data, where Y is a natural number greater than or equal to two.

In some example embodiments, each of the plurality of event frames may include event header information. For example, the first event frame EIMG1 may include first event header information EH1 which includes first time information TINF1 associated with the first event frame EIMG1, but is not limited thereto, the second event frame EIMG2 may include second event header information EH2 which includes second time information TINF2 associated with the second event frame EIMG2, but is not limited thereto, and the X-th event frame EIMGX may include X-th event header information EHX which includes X-th time information TINFX associated with the X-th event frame EIMGX, but is not limited thereto. For example, the first time information TINF1 may indicate a time point at which the first event frame EIMG1 is generated and/or output from the dynamic vision sensor.

Typically, vision or image sensors capture a series of still frames, as in conventional video and computer vision systems. Each “frame” is associated with a desired and/or pre-defined size of a pixel array, typically every pixel of an image sensor exposed to the luminance being sensed. As is understood, a “pixel” is a basic unit of an image sensor and can be considered as the smallest controllable element of the image sensor.

In conventional image sensors, successive frames contain enormous amounts of redundant information (e.g., information that is exactly the same as information in a previous frame), wasting memory space, energy, computational power, and/or time. In addition, in a frame-based sensing approach, each frame imposes the same exposure time on every pixel in the frame, thereby making it difficult to deal with scenes containing very dark and very bright regions.

The dynamic vision sensor captures a change and/or difference in pixel luminance (e.g., an event) within a scene and outputs a stream of events, where each event has a state. The state of the event includes a location of the event within a camera array and a signed binary value (e.g., a signed one-bit value) indicating either a positive change, or a negative change in the luminance of the associated event as compared to an immediately preceding state of the associated location. For example, the state of the event at a desired pixel location may include either a value of “+1” to indicate a positive change in luminance of the event during a desired period of time based on the value of the signed binary value, a value of “−1” to indicate a negative change in luminance of the event during the desired period of time based on the value of the signed binary value, or may further include a value of “0” to indicate no change in luminance of the event during the desired period of time based on no binary value being output by the camera array for the desired pixel location, as compared to an immediately preceding event state of the associated location (e.g., the pixel of the dynamic vision sensor).

Generally, the dynamic vision sensor detects a change of light intensity to output an event related thereto. More particularly, the dynamic vision sensor detects a portion of the subject in which a motion occurs and outputs events related thereto by a unit of the time-stamp (e.g., the image capture frame rate of the dynamic vision sensor, the latency of the dynamic vision sensor, etc.). Additionally, because the dynamic vision sensor outputs substantially smaller data per frame than a conventional image sensor, the dynamic vision sensor “captures” at a higher frame rate than conventional image sensors (e.g., 1 microsecond vs. 1 millisecond, etc.). Thus, the dynamic vision sensor may be referred to as a time-stamp based sensor and/or an event based sensor.

After the plurality of event frames are obtained, a data format conversion is performed to convert the plurality of event frames into at least one image frame (step S200). The at least one image frame may have one of various image formats (e.g., color space formats, etc.), such as RGB (Red, Green, Blue), CMY (Cyan, Magenta, Yellow), YUV (Luminance-Bandwidth-Chrominance), YCbCr (Luminance, Chroma-Blue, Chroma-Red in digital video), YPbPr (also referred to as “component video” is the analog version of the YCbCr color space), etc. Each image frame may include a plurality of image pixel data, and each image pixel data may include N-bit data, where N is a natural number greater than or equal to two.

For example, as illustrated in FIG. 2, the at least one image frame may include a first image frame IIMG1. For example, the first image frame IIMG1 may include first image pixel data P1 which is N-bit data. Although not illustrated in detail in FIG. 2, each image frame may include Z image pixel data, where Z is a natural number greater than or equal to two.

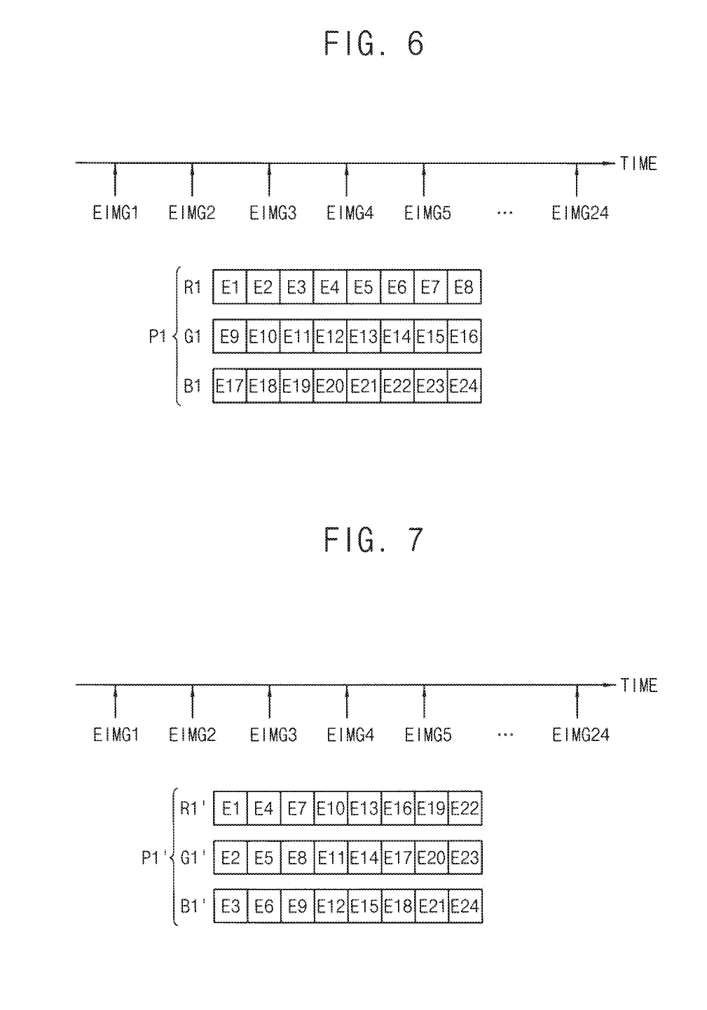

In some example embodiments, the data format conversion may be performed to convert N event pixel data each of which is one-bit data into a single image pixel data which is N-bit data. Examples of the data format conversion will be described in detail with reference to FIGS. 6, 7 and 8.

In some example embodiments, the at least one image frame may include header information, but is not limited thereto. The header information may include time information associated with the plurality of event frames and/or conversion scheme information associated with the data format conversion, etc. For example, the first image frame IIMG1 may include first header information IH1, etc. The first header information IH1 may include the first through X-th time information TINF1, TINF2, . . . , TINFX associated with the first through X-th event frames EIMG1, EIMG2, . . . , EIMGX, and conversion scheme information CINF which indicates corresponding relationships between the event pixel data E1, E2, . . . , EX included in the first through X-th event frames EIMG1, EIMG2, . . . , EIMGX and the image pixel data P1 included in the first image frame IIMG1. The first through X-th event frames EIMG1, EIMG2, . . . , EIMGX may be restored (e.g., generated, obtained, etc.) from the first image frame IIMG1 using the first header information IH1.

After the at least one image frame is obtained by the data format conversion, an image compression is performed to compress the at least one image frame (step S300). A compressed image frame CIMG may be obtained as a result of the image compression.

In some example embodiments, the image compression may be performed using at least one of lossless or lossy compression coding schemes. For example, the image compression may be performed using a video coder/decoder (codec) based on at least one of various international standards of video encoding/decoding, such as MPEG (Moving Picture Expert Group)-1, MPEG-2, H.261, H.262 (or MPEG-2 Part 2), H.263, MPEG-4, AVC (Advanced Video Coding), HEVC (High Efficiency Video Coding), etc. AVC is also known as H.264 or MPEG-4 part 10, and HEVC is also known as H.265 or MPEG-H Part 2.

After the image compression is performed, the compressed image frame CIMG obtained as a result of the image compression may be stored (step S400). For example, the compressed image frame CIMG may be stored into an external memory and/or storage (not illustrated), but is not limited thereto.

In some example embodiments, the event frames EIMG1, EIMG2, EIMGX output from the dynamic vision sensor may be used in an application and/or application unit (e.g., visual recognition, simultaneous localization and mapping (SLAM), pattern recognition, scene understanding, gesture recognition for gesture based user-device interaction (e.g., television (TV), video games, user interface controls, VR/AR applications, etc), user recognition (e.g., for TV, mobile device, smart device, Internet of Things (IoT) device, etc.), robotics, etc.) that requires the event frames EIMG1, EIMG2, EIMGX. For example, the event frames EIMG1, EIMG2, . . . , EIMGX may be obtained and used by loading the compressed image frame CIMG stored in the external memory and/or storage, decompressing the compressed image frame CIMG to obtain the image frame IIMG1 using the codec, and restoring the event frames EIMG1, EIMG2, . . . , EIMGX from the image frame IIMG1 using the header information IH1.

In the method of processing data for the dynamic vision sensor according to one or more example embodiments, the event frames EIMG1, EIMG2, . . . , EIMGX output from the dynamic vision sensor may be converted into the image frame IIMG1 having general, original and/or typical image format, the image frame IIMG1 may be compressed to obtain the compressed image frame CIMG, and the compressed image frame CIMG may be stored. In other words, the compressed image frame CIMG having a relatively small amount of data may be stored as the output of the dynamic vision sensor rather than storing the event frames EIMG1, EIMG2, . . . , EIMGX having a relatively large amount of data. Accordingly, data corresponding to the event frames may be efficiently stored into a limited, reduced, and/or confined storage space even if the number of events (e.g., the number of the event frames) increases, and the dynamic vision sensor may have the enhanced performance even if a relatively low speed data interface is employed to the dynamic vision sensor.

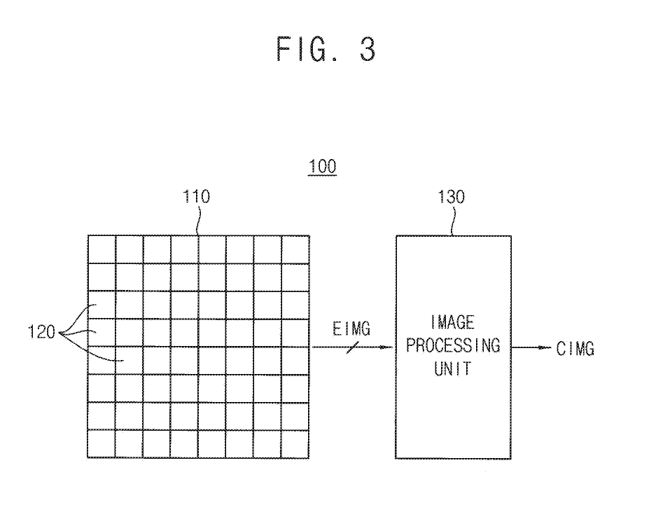

FIG. 3 is a block diagram illustrating a dynamic vision sensor according to one or more example embodiments.

Referring to FIG. 3, a dynamic vision sensor 100 includes a pixel array 110 and/or an image processing unit 130 (e.g., an image processor, etc.), etc., but the example embodiments are not limited thereto.

The pixel array 110 includes a plurality of sensing pixels or a plurality of pixels 120. The pixel array 110 detects changes of light to output a plurality of event frames EIMG. In other words, step S100 in FIG. 1 may be performed by the pixel array 110.

For example, the pixel array 110 is shown to include 64 pixel regions or pixels 120, but the example embodiments are not limited thereto. Because of each pixel of a pixel array 110 are typically identical in construction, each pixel or pixel region in the array 110 is identified using the same reference numeral “120” for convenience of descriptions, but are not limited thereto.

Although FIG. 3 illustrates the 8*8 pixel array 110 including 64 pixel regions or pixels 120, the example embodiments are not limited thereto. For example, a size of the pixel array 110 and/or the number of pixels included in the pixel array 110 may be changed.

The image processing unit 130 performs a data format conversion to convert the plurality of event frames EIMG into at least one image frame, performs an image compression to compress the at least one image frame, and outputs a compressed image frame CIMG as a result of the image compression. In other words, steps S200 and S300 may be performed by the image processing unit 130.

Although not illustrated in FIG. 3, the dynamic vision sensor 100 may further include a control unit, a controller, and/or control module for controlling an operation of the pixel array 110 (e.g., a pixel array controller, etc.).

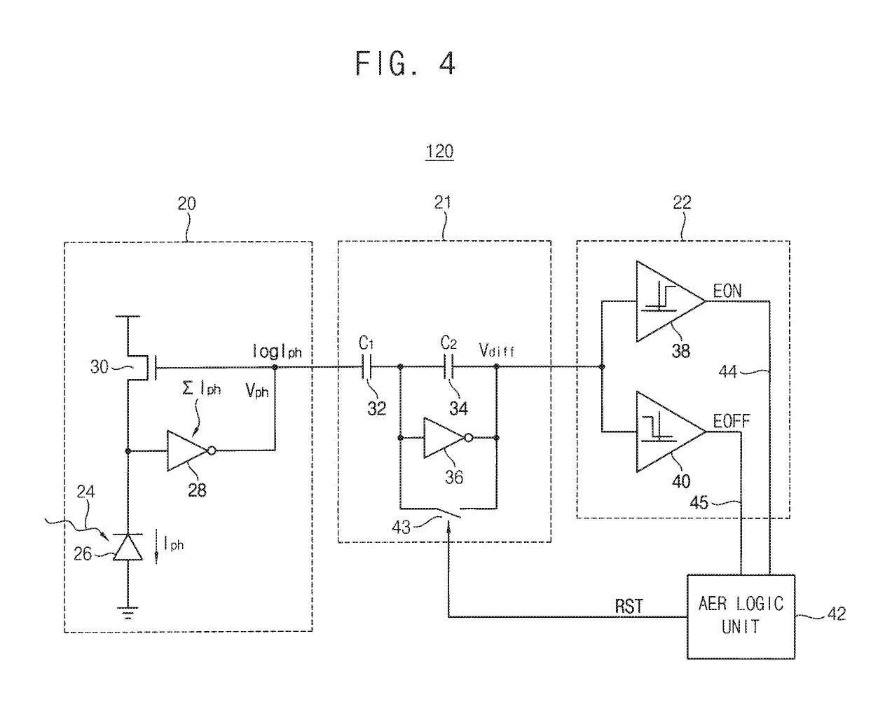

FIG. 4 is a circuit diagram illustrating an example of a pixel included in a dynamic vision sensor according to one or more example embodiments.

Referring to FIGS. 3 and 4, the pixel 120 included in the dynamic vision sensor 100 may include a photoreceptor 20, a differentiator unit 21 and/or a comparator unit 22, etc., but is not limited thereto.

The pixel 120 may use an active continuous-time logarithmic photoreceptor 20 followed by a well-matched self-timed switched-capacitor differencing amplifier 21, but is not limited thereto. For the temporal contrast computation, each pixel 120 in the dynamic vision sensor 100 may monitor and/or continuously monitor its photocurrent for changes. The incident luminance 24 may be received by a photodiode 26, which, in turn, generates corresponding photocurrent Iₚₕ. All the photocurrent (ΣIₚₕ) generated during a sampling period (e.g., a sampling period of a desired time period) may be logarithmically encoded (log Iₚₕ) by an inverter 28 into a photoreceptor output voltage Vₚₕ.

A source-follower buffer 30 may isolate the photoreceptor 20 from the next stage 21. Thus, the photoreceptor 20 may function as a transducer to convert received luminance/light signal into a corresponding electrical voltage Vₚₕ. The self-timed switched-capacitor differencing amplifier 21 may amplify the deviation in the photocurrent's log intensity (log Iₚₕ) from the differentiator unit-specific last reset level.

The matching of capacitors, e.g., capacitors C₁ and C₂ (identified by reference numerals “32” and “34,” respectively), may give the differentiator unit 21 a precisely defined gain for amplifying the changes in log intensity. The difference voltage V_{diff} at the output of an inverting amplifier 36 may be given by: V_{diff}=A*d(log Iₚₕ), where “A” represents the amplification gain of the differentiator unit 21 and “d(log Iₚₕ)” is the differentiation of the log intensity.

In the comparator unit 22, the deviation V_{diff} may be compared and/or continuously compared against a desired number of thresholds, e.g., two thresholds. The comparator unit 22 may include, for example, two comparators 38 and 40, each comparator providing one of the desired thresholds, e.g., the two thresholds, for comparison. For example, as soon as either of the two comparator thresholds is crossed, an address event (AE) (or, simply, an “event”) may be communicated to a pixel-specific address event representation (AER) logic unit 42, and the switched-capacitor differencing amplifier 21 may be reset—as symbolically illustrated by a switch 43—to store the new illumination level until next sampling interval. Thus, the pixel 120 may perform a data-driven analog-to-digital (AD) conversion.

An increase in the intensity of the incident light 24 may lead to an “ON event (EON),” whereas a decrease may produce an “OFF event (EOFF).” As illustrated in FIG. 4, the first comparator 38 may respond with an “ON event” signal 44 representing a fractional increase in the received luminance that exceeds a comparator-specific tunable threshold (e.g., desired threshold). Similarly, the second comparator 40 may respond with an “OFF event” signal 45 when a fractional decrease in the received luminance exceeds a comparator-specific tunable threshold (e.g., desired threshold). The ON and OFF events may be communicated asynchronously to a digital control module (not illustrated in FIGS. 3 and 4) in the dynamic vision sensor 100 using AER. This approach may make efficient use of the AER protocol because events are communicated immediately, while pixels that sense no changes are silent.

For each pixel 120 in the dynamic vision sensor 100, the digital control module may include a pixel-specific AER logic unit such as, for example, the unit 42. To communicate the DVS events, the dynamic vision sensor 100 may use word serial burst mode AER circuits in the digital control module, but the example embodiments are not limited thereto, for example the dynamic vision sensor 100 may use parallel communications to the digital control module. If V_{diff} crosses the threshold of either comparator 38 or 40, the pixel 120 may first request in the row direction. A non-greedy arbitration circuit (not illustrated) in the digital control module may choose among all of the requesting rows and acknowledge a single row at a time. In this selected row, all of the pixels that have crossed the threshold (for ON event or OFF event) may assert a corresponding request signal in the column direction. A small asynchronous state machine in each column may latch the state of the request lines (whether requesting or not).

A simplified arbitration tree may choose a column, such as the leftmost requesting column, and all addresses of the requesting columns are then sequentially read out. Thus, all events in a column burst may receive the same timestamp in microsecond resolution. Different rows may be sequentially selected during a sampling interval to perform the motion detection. Given certain integration time, the output of the dynamic vision sensor 100 may contain an asynchronous stream of pixel address events that directly encode the changes in the reflectance of the scene being monitored/detected.

Although an example of configuration and operation of the pixel 120 included in the dynamic vision sensor 100 is described with reference to FIG. 4, the example embodiments of the inventive concepts are not limited thereto. For example, the configuration and/or operation of the pixel 120 may be changed.

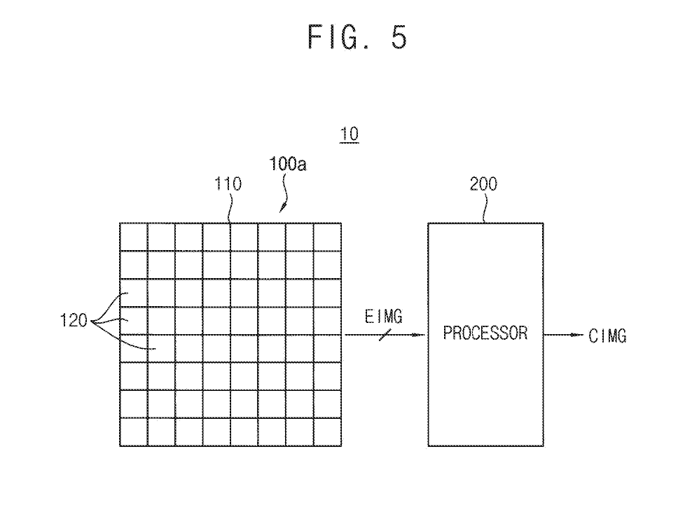

FIG. 5 is a block diagram illustrating an electronic device including a dynamic vision sensor according to one or more example embodiments. The descriptions repeated with FIG. 3 may be omitted.

Referring to FIG. 5, an electronic device 10 includes a dynamic vision sensor 100a, and/or at least one processor 200, etc., but is not limited thereto. For example, in some example embodiments the at least one processor 200 may be integrated into the dynamic vision sensor 100a, and/or the funcationality of the at least one processor 200 may be performed by the dynamic vision sensor 100a.

The dynamic vision sensor 100a is controlled by the at least one processor 200 and detects changes of light to output a plurality of event frames EIMG. In other words, step S100 in FIG. 1 may be performed by the dynamic vision sensor 100a.

The at least one processor 200 performs a data format conversion to convert the plurality of event frames EIMG into at least one image frame, performs an image compression to compress the at least one image frame, and outputs a compressed image frame CIMG as a result of the image compression. In other words, steps S200 and S300 may be performed by the processor 200 which is disposed and/or located outside the dynamic vision sensor 100a. Thus, unlike the dynamic vision sensor 100 of FIG. 3, the image processing unit 130 may not be included (or may be omitted) in the dynamic vision sensor 100a of FIG. 5.

In some example embodiments, the at least one processor 200 may be one of various processing units such as a central processing unit (CPU), a microprocessor, an application processor (AP), or the like. For example, the at least one processor 200 may be driven by executing an operating system (OS) loaded with special purpose computer readable instructions which transform the at least one processor 200 into a special purpose processor for performing the method operations of one or more of the example embodiments. In addition, the at least one processor 200 may execute a plurality of applications provide various services. For example, the at least one processor 200 may execute a video application, a game application, a web browser application, etc.

FIGS. 6, 7 and 8 are diagrams for describing a method of processing data for a dynamic vision sensor according to example embodiments.

Referring to FIG. 6, an example where 24 event frames EIMG1, EIMG2, EIMG3, EIMG4, EIMG5, . . . , EIMG24 are converted into a single image frame (e.g., the first image frame IIMG1 in FIG. 2), the image frame includes first image pixel data P1 which is 24-bit data, the first image pixel data P1 is data of RGB image format that includes first red data R1, first green data G1 and first blue data B1, and each of the first red data R1, the first green data G1 and the first blue data B1 includes 8-bit data (e.g., (24/3)-bit data) is illustrated in FIG. 6. In other words, FIG. 6 illustrates an example of FIG. 2 where X=N=24.

The first through twenty-fourth event frames EIMG1, EIMG2, EIMG3, EIMG4, EIMG5, . . . , EIMG24 may be sequentially generated and output by lapse of time (e.g., over a period of time). For example, the first event frame EIMG1 may be output first, and the twenty-fourth event frame EIMG24 may be output at the end. Although FIG. 6 illustrates time intervals between two consecutive event frames that are substantially the same as each other, events or event frames may not regularly occur in fact, and thus the time intervals between two consecutive event frames may be different from one another.

The first through twenty-fourth event frames EIMG1, EIMG2, EIMG3, EIMG4, EIMG5, . . . , EIMG24 may include first through twenty-fourth event pixel data E1, E2, E3, E4, E5, E6, E7, E8, E9, E10, E11, E12, E13, E14, E15, E16, E17, E18, E19, E20, E21, E22, E23 and E24, respectively. Each of the first through twenty-fourth event pixel data E1, E2, E3, E4, E5, E6, E7, E8, E9, E10, E11, E12, E13, E14, E15, E16, E17, E18, E19, E20, E21, E22, E23 and E24 may include one-bit data and may be disposed at the same location in a respective one of the first through twenty-fourth event frames EIMG1, EIMG2, EIMG3, EIMG4, EIMG5, . . . , EIMG24. For example, the first event frame EIMG1 may include the first event pixel data E1, and the twenty-fourth event frame EIMG24 may include the twenty-fourth event pixel data E24. For example, as illustrated in FIG. 2, the event pixel data E1, E2, E3, E4, E5, E6, E7, E8, E9, E10, E11, E12, E13, E14, E15, E16, E17, E18, E19, E20, E21, E22, E23 and E24 may be disposed or located at the top-left corner (e.g., at a first row and a first column) in the event frames EIMG1, EIMG2, EIMG3, EIMG4, EIMG5, . . . , EIMG24, respectively, but is not limited thereto.

To convert the first through twenty-fourth event frames EIMG1, EIMG2, EIMG3, EIMG4, EIMG5, . . . , EIMG24 into the first image frame IIMG1, the first through twenty-fourth event pixel data E1, E2, E3, E4, E5, E6, E7, E8, E9, E10, E11, E12, E13, E14, E15, E16, E17, E18, E19, E20, E21, E22, E23 and E24 corresponding to the same pixel location may be assigned to first through twenty-fourth bits of the first image pixel data P1. Each event pixel data may be one-bit data, and the first image pixel data P1 may be 24-bit data. As with the first through twenty-fourth event pixel data E1, E2, E3, E4, E5, E6, E7, E8, E9, E10, E11, E12, E13, E14, E15, E16, E17, E18, E19, E20, E21, E22, E23 and E24, the first image pixel data P1 may be disposed or located at the top-left corner (e.g., at a first row and a first column) in the first image frame IIMG1.

For example, as illustrated in FIG. 6, the first through eighth event pixel data E1, E2, E3, E4, E5, E6, E7 and E8 may be sequentially assigned to first through eighth bits of the first red data R1, respectively, the ninth through sixteenth event pixel data E9, E10, E11, E12, E13, E14, E15 and E16 may be sequentially assigned to first through eighth bits of the first green data G1, respectively, and the seventeenth through twenty-fourth event pixel data E17, E18, E19, E20, E21, E22, E23 and E24 may be sequentially assigned to first through eighth bits of the first blue data B1, respectively, but are not limited thereto. For example, the event pixel data E1, E9 and E17 may correspond to a most significant bit (MSB) of the first red, green and blue data R1, G1 and B 1, and the event pixel data E8, E16 and E24 may correspond to a least significant bit (LSB) of the first red, green and blue data R1, G1 and B1, but the example embodiments are not limited thereto.

Although not illustrated in FIG. 6, the first through twenty-fourth event frames EIMG1, EIMG2, EIMG3, EIMG4, EIMG5, . . . , EIMG24 may further include twenty-fifth through forty-eighth event pixel data, respectively, and the first image frame IIMG1 may further include second image pixel data. Each of the twenty-fifth through forty-eighth event pixel data may be one-bit data and correspond to another same pixel location (e.g., a second pixel location, such as pixel located at a first row and a second column, etc.), and the second image pixel data may be 24-bit data. To convert the first through twenty-fourth event frames EIMG1, EIMG2, EIMG3, EIMG4, EIMG5, . . . , EIMG24 into the first image frame IIMG1, the twenty-fifth through forty-eighth event pixel data may be assigned to bits of the second image pixel data based on the above described scheme. As such, all event pixel data in the first through twenty-fourth event frames EIMG1, EIMG2, EIMG3, EIMG4, EIMG5, . . . , EIMG24 may be assigned to bits of all of the image pixel data in the first image frame IIMG1, and thus the data format conversion may be completed.

Referring to FIG. 7, an example where 24 event frames EIMG1, EIMG2, EIMG3, EIMG4, EIMG5, . . . , EIMG24 are converted into a single image frame (e.g., the first image frame IIMG1 in FIG. 2), the image frame includes first image pixel data P1′ which is 24-bit data, the first image pixel data P1′ is data of RGB image format that includes first red data R1′, first green data G1′ and first blue data B1′, and each of the first red data R1′, the first green data G1′ and the first blue data B1′ includes 8-bit data (e.g., (24/3)-bit data) is illustrated in FIG. 7. An example of FIG. 7 may be substantially the same as an example of FIG. 6, except that the assigned locations of the event pixel data E1, E2, E3, E4, E5, E6, E7, E8, E9, E10, E11, E12, E13, E14, E15, E16, E17, E18, E19, E20, E21, E22, E23 and E24 may be changed. Thus, the descriptions repeated with FIG. 6 may be omitted.

To convert the first through twenty-fourth event frames EIMG1, EIMG2, EIMG3, EIMG4, EIMG5, . . . , EIMG24 into the first image frame IIMG1, the first through twenty-fourth event pixel data E1, E2, E3, E4, E5, E6, E7, E8, E9, E10, E11, E12, E13, E14, E15, E16, E17, E18, E19, E20, E21, E22, E23 and E24 corresponding to the same pixel location may be assigned to first through twenty-fourth bits of the first image pixel data P1′.

For example, as illustrated in FIG. 7, the first, fourth, seventh, tenth, thirteenth, sixteenth, nineteenth and twenty-second event pixel data E1, E4, E7, E10, E13, E16, E19 and E22 may be sequentially assigned to first through eighth bits of the first red data R1′, respectively, the second, fifth, eighth, eleventh, fourteenth, seventeenth, twentieth and twenty-third event pixel data E2, E5, E8, E11, E14, E17, E20 and E23 may be sequentially assigned to first through eighth bits of the first green data G1′, respectively, and the third, sixth, ninth, twelfth, fifteenth, eighteenth, twenty-first and twenty-fourth event pixel data E3, E6, E9, E12, E15, E18, E21 and E24 may be sequentially assigned to first through eighth bits of the first blue data B1′, respectively.

As described above, the data format conversion may be performed to convert N event pixel data each of which is one-bit data into one image pixel data which is N-bit data, and the N event pixel data may be obtained from two or more different event frames among the plurality of event frames, as illustrated in FIGS. 6 and 7. In addition, the event pixel data corresponding to the same pixel location may be assigned to the image pixel data corresponding to the same pixel location based on time sequential scheme (e.g., in sequential order of generation of event frames).

An example of FIG. 6 may be extended to assign the first event pixel data through (N/3)-th event pixel data among the N event pixel data to bits in the first red data, to assign (N/3+1)-th event pixel data through (2N/3)-th event pixel data among the N event pixel data to bits in the first green data, and to assign (2N/3+1)-th event pixel data through the N-th event pixel data among the N event pixel data to bits in the first blue data. An example of FIG. 7 may be extended to assign (3K−2)-th event pixel data among the N event pixel data to bits in the first red data, to assign (3K−1)-th event pixel data among the N event pixel data to bits in the first green data, and to assign 3K-th event pixel data among the N event pixel data to bits in the first blue data, where K is a natural number greater than or equal to one and smaller than or equal to N/3.

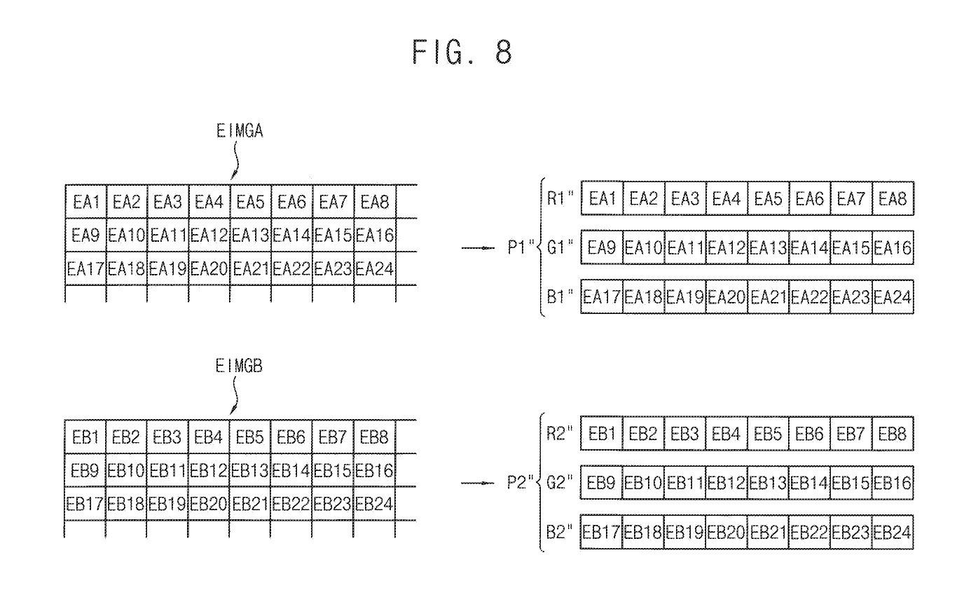

Referring to FIG. 8, an example where two or more event frames EIMGA and EIMGB are converted into a single image frame (e.g., the first image frame IIMG1 in FIG. 2), the image frame includes first image pixel data P1″ and second image pixel data P2″ each of which is 24-bit data, the first image pixel data P1″ is data of RGB image format that includes first red data R1″, first green data G1″ and first blue data B1″, the second image pixel data P2″ is data of RGB image format that includes second red data R2″, second green data G2″ and second blue data B2″, and each of the red data R1″ and R2″, the green data G1″ and G2″ and the blue data B1″ and B2″ includes 8-bit data (e.g., (24/3)-bit data) is illustrated in FIG. 8. In other words, FIG. 8 illustrates an example of FIG. 2 where X>=2 and N=24, however the example embodiments are not limited thereto.

The first event frame EIMGA may include first through twenty-fourth event pixel data EA1, EA2, EA3, EA4, EA5, EA6, EA7, EA8, EA9, EA10, EA11, EA12, EA13, EA14, EA15, EA16, EA17, EA18, EA19, EA20, EA21, EA22, EA23 and EA24 that are disposed at different locations in the first event frame EIMGA. The second event frame EIMGB may include twenty-fifth through forty-eighth event pixel data EB1, EB2, EB3, EB4, EB5, EB6, EB7, EB8, EB9, EB10, EB11, EB12, EB13, EB14, EB15, EB16, EB17, EB18, EB19, EB20, EB21, EB22, EB23 and EB24 that are disposed at different locations in the second event frame EIMGB. Each event pixel data may be one-bit data, but is not limited thereto.

To convert the first and second more event frames EIMGA and EIMGB into the first image frame IIMG1, the first through twenty-fourth event pixel data EA1, EA2, EA3, EA4, EA5, EA6, EA7, EA8, EA9, EA10, EA11, EA12, EA13, EA14, EA15, EA16, EA17, EA18, EA19, EA20, EA21, EA22, EA23 and EA24 may be assigned to first through twenty-fourth bits of the first image pixel data P1″, and the twenty-fifth through forty-eighth event pixel data EB1, EB2, EB3, EB4, EB5, EB6, EB7, EB8, EB9, EB10, EB11, EB12, EB13, EB14, EB15, EB16, EB17, EB18, EB19, EB20, EB21, EB22, EB23 and EB24 may be assigned to first through twenty-fourth bits of the second image pixel data P2″, as illustrated in FIG. 8.

As described above, the data format conversion may be performed to convert N event pixel data each of which is one-bit data into one image pixel data which is N-bit data, and the N event pixel data may be obtained from one event frame among the plurality of event frames, as illustrated in FIG. 8. In addition, a location of the image pixel data to be assigned may be determined based on an order of the event frame and a location of the event pixel data in the event frame.

Although examples are described with reference to FIGS. 6, 7 and 8 based on the specific number of event frames, the specific bit number of image pixel data, etc., the example embodiments of the inventive concepts are not limited thereto. For example, as described with reference to FIG. 1, when the X event frames, each of which includes the Y event pixel data (e.g., Y one-bit data), are converted into one image frame which includes the Z image pixel data (e.g., Z N-bit data), an equation X*Y=N*Z may be satisfied.

In addition, although examples where the event pixel data obtained from two or more event frames are converted into one image pixel data are described with reference to FIGS. 6 and 7, and although an example where the event pixel data obtained from one event frame are converted into one image pixel data are described with reference to FIG. 8, the example embodiments of the inventive concepts are not limited thereto. For example, the data format conversion may be performed based on one of various schemes where there is a one-to-one correspondence between all of the event pixel data and all of the bits of the image pixel data (e.g., a scheme where the event pixel data are time-sequentially assigned to bits of the image pixel data, a scheme where the event pixel data are assigned to bits of the image pixel data according to the pixel locations, etc.), etc.

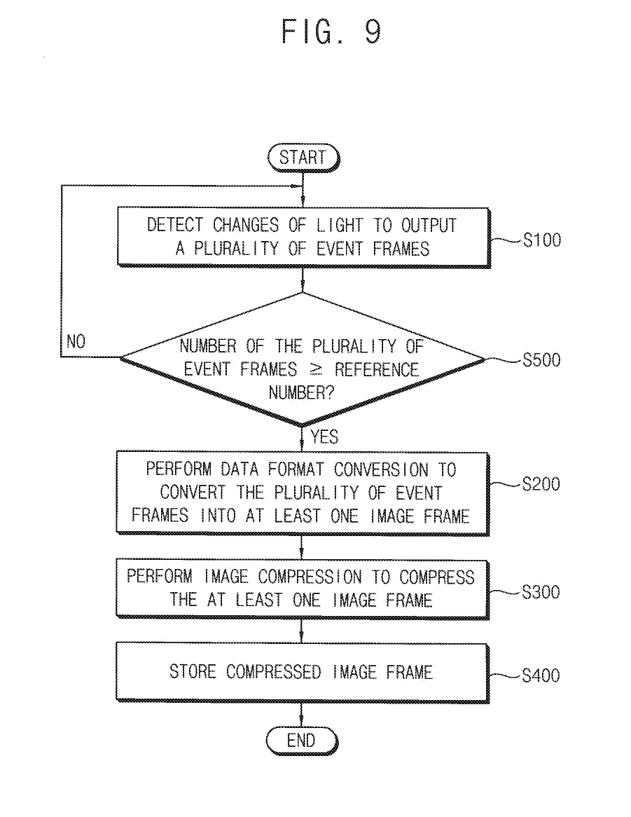

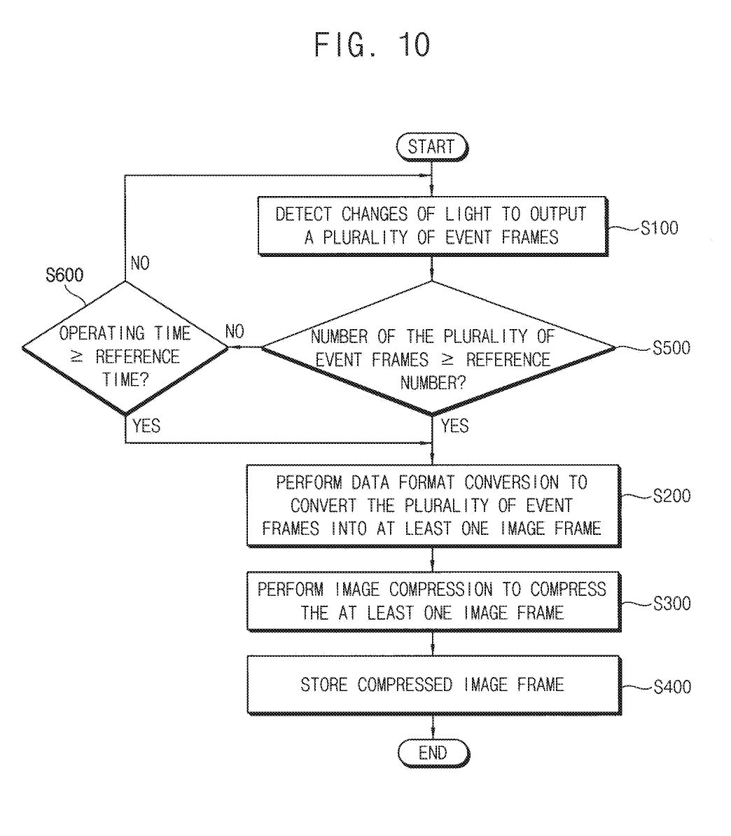

FIGS. 9 and 10 are flow charts illustrating a method of processing data for a dynamic vision sensor according to some example embodiments. The descriptions repeated with FIG. 1 may be omitted.

Referring to FIG. 9, in a method of processing data for a dynamic vision sensor, at least one processor connected to and/or controlling the dynamic vision sensor may check the number of the plurality of event frames output from the dynamic vision sensor (step S500) after the plurality of event frames are obtained and before the data format conversion is performed.

When the number of the plurality of event frames is greater than or equal to a desired and/or predetermined reference number (step S500: YES), the data format conversion may be performed by the at least one processor (step S200). After the data format conversion is performed, the counted number of the plurality of event frames may be reset, and steps S100 and S500 may be repeated based on the reset number. When the number of the plurality of event frames is smaller than the reference number (step S500: NO), the at least one processor may stand by or wait to generate and output the event frames until when the number of the plurality of event frames is greater than or equal to the reference number.

For example, in an example of FIG. 6 where 24 event frames EIMG1, EIMG2, EIMG3, EIMG4, EIMG5, . . . , EIMG24 are converted into a single image frame IIMG1, the data format conversion may not be performed until 24 event frames are generated and accumulated. The data format conversion and the image compression may be performed to generate and store the compressed image frame CIMG after 24 event frames are generated, however the example embodiments are not limited thereto and, for example, the event frames may be generated and output as each frame is generated, etc.

Referring to FIG. 10, in a method of processing data for a dynamic vision sensor, it may be further checked an operating time of the dynamic vision sensor (step S600) after the plurality of event frames are obtained and before the data format conversion is performed.

When the number of the plurality of event frames is greater than or equal to a desired and/or predetermined reference number (step S500: YES), the data format conversion may be performed by at least one processor (step S200). When the operating time is longer than or equal to a desired and/or predetermined reference time even if the number of the plurality of event frames is smaller than the reference number (step S500: NO and step S600: YES), the data format conversion may be performed by at least one processor (step S200). After the data format conversion is performed, the counted number of the plurality of event frames and the measured operating time may be reset, and steps S100, S500 and S600 may be repeated based on the reset number and reset time. When the number of the plurality of event frames is smaller than the reference number (step S500: NO), and when the operating time is shorter than the reference time (step S600: NO), the at least one processor may stand by or wait to generate and output of the event frames until the number of the plurality of event frames is greater than or equal to the reference number, or the at least one processor may stand by or wait until when the operating time is longer than or equal to the reference time.

For example, in an example of FIG. 6 where 24 event frames EIMG1, EIMG2, EIMG3, EIMG4, EIMG5, . . . , EIMG24 are converted into a single image frame IIMG1, the data format conversion and the image compression may be performed to generate and store the compressed image frame CIMG after 24 event frames are generated. In addition, as described above, events or event frames may not regularly occur in fact, and it may be a waste of time and resources waiting until when 24 event frames are generated. Thus, even if the number of the plurality of event frames generated within the reference time is smaller than 24, e.g., even if only 20 event frames are generated within the reference time, only 20 event frames may be converted into one image frame (e.g., IIMG1). For example, when only 20 event frames are converted into one image frame, the first through twentieth event pixel data E1, E2, E3, E4, E5, E6, E7, E8, E9, E10, E11, E12, E13, E14, E15, E16, E17, E18, E19 and E20 may have a normal value (e.g., a binary value indicating either a positive or a negative change in the luminance of the associated event), and the twenty-first through twenty-fourth event pixel data E21, E22, E23 and E24 may have a default value or an empty value.

In some example embodiments, at least a part of the method of processing data according to one or more example embodiments may be implemented as hardware. In other example embodiments, at least a part of the method of processing data according to one or more example embodiments may be implemented as special purpose computer readable instructions or special purpose program routines (e.g., a specialized software program) for performance by hardware.

As will be appreciated by those skilled in the art, the example embodiments of the inventive concepts may be embodied as a system, method, computer program product, and/or a computer program product embodied in one or more computer readable medium(s) having computer readable program code embodied thereon. The computer readable program code may be loaded onto a processor of a general purpose computer, special purpose computer, or other programmable data processing apparatus, thereby transforming the processor into a special purpose processor to implement the computer readable instructions of the one or more example embodiments of the inventive concepts. The computer readable medium may be a computer readable signal medium or a computer readable storage medium. The computer readable storage medium may be any tangible medium that can contain, or store a program for use by or in connection with an instruction execution system, apparatus, or device. For example, the computer readable medium may be a non-transitory computer readable medium.

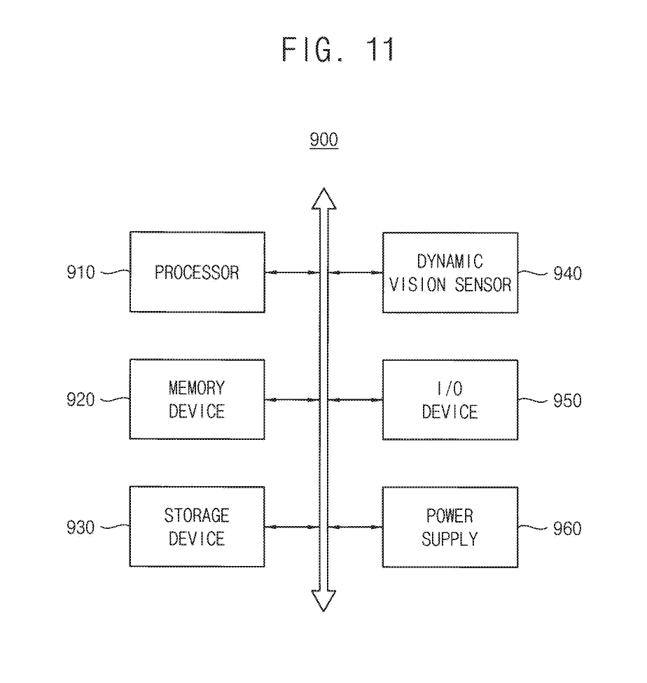

FIG. 11 is a block diagram illustrating an electronic system including a dynamic vision sensor according to one or more example embodiments.

Referring to FIG. 11, an electronic device or system 900 may include at least one processor 910, a memory device 920, a storage device 930, a dynamic vision sensor 940, an input/output (I/O) device 950 and/or a power supply 960, but not limited thereto.

The at least one processor 910 may perform various calculations or tasks for operating the electronic system 900. For example, the at least one processor 910 may include a microprocessor, a CPU, an AP, etc. The memory device 920 and the storage device 930 may store data for operating the electronic system 900. For example, the memory device 920 may include a volatile memory device and/or a nonvolatile memory device, and the storage device 930 may include a solid state drive (SSD), a hard disk drive (HDD), a CD-ROM, etc. The I/0 device 950 may include an input device (e.g., a keyboard, a keypad, a mouse, a microphone, a camera, etc.) and an output device (e.g., a printer, a display device, a speaker, a haptic feedback device, etc.). The power supply 960 may supply operation voltages for the electronic system 900.

The dynamic vision sensor 940 may be a dynamic vision sensor according to one or more example embodiments. For example, the dynamic vision sensor 940 may be the dynamic vision sensor 100 of FIG. 3, and steps S100, S200 and S300 in FIG. 1 may be performed by the dynamic vision sensor 940. For another example, the dynamic vision sensor 940 may be the dynamic vision sensor 100a of FIG. 5, step S100 in FIG. 1 may be performed by the dynamic vision sensor 940, and steps S200 and S300 in FIG. 1 may be performed by the processor 910. The compressed image frame CIMG may be stored in at least one of the memory device 920 and the storage device 930.

The example embodiments of the inventive concept may be applied to various devices and systems that include the dynamic vision sensor. For example, the inventive concept may be applied to systems such as a mobile phone, a smart phone, a tablet computer, a laptop computer, a personal digital assistant (PDA), a portable multimedia player (PMP), a digital camera, a game console, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, etc.

The foregoing is illustrative of various example embodiments and is not to be construed as limiting thereof. Although a few example embodiments have been described, those skilled in the art will readily appreciate that many modifications are possible in the example embodiments without materially departing from the novel teachings and advantages of the inventive concepts. Accordingly, all such modifications are intended to be included within the scope of the inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of processing data for a dynamic vision sensor, the method comprising:
detecting, using at least one processor, changes of light sensed by a dynamic vision sensor;
outputting, using the at least one processor, a plurality of event frames from the dynamic vision sensor based on the detected changes of light;
converting, using the at least one processor, the plurality of event frames into at least one image frame; and
compressing, using the at least one processor, the at least one image frame.

2. The method of claim 1, wherein:
each of the plurality of event frames includes a plurality of event pixel data;
each of the plurality of event pixel data includes one-bit data; and
the at least one image frame includes a plurality of image pixel data, each of the plurality of image pixel data including N-bit data, where N is a natural number greater than or equal to two.

3. The method of claim 2, wherein the converting the plurality of event frames into at least one image frame includes:
converting N event pixel data into one image pixel data.

4. The method of claim 3, wherein the N event pixel data are obtained from two or more different event frames among the plurality of event frames.

5. The method of claim 3, wherein the N event pixel data are obtained from one event frame among the plurality of event frames.

6. The method of claim 1, wherein:
the plurality of event frames include first through N-th event frames, where N is a natural number greater than or equal to two;
the at least one image frame includes a first image frame; and
the converting the plurality of event frames into at least one image frame includes converting the first through N-th event frames into the first image frame.

7. The method of claim 6, wherein:
the first through N-th event frames include first through N-th event pixel data, respectively;
each of the first through N-th event pixel data includes one-bit data and each of the first through N-th event pixel data is disposed at a first location in a respective one of the first through N-th event frames;
the first image frame includes first image pixel data that includes N-bit data; and
the converting the first through N-th event frames into the first image frame includes assigning the first through N-th event pixel data to first through N-th bits in the first image pixel data.

8. The method of claim 7, wherein:
the first image pixel data includes first red data, first green data and first blue data; and
each of the first red data, the first green data and the first blue data includes (N/3)-bit data, where N is a multiple of three.

9. The method of claim 8, wherein the assigning the first through N-th event pixel data to the first through N-th bits in the first image pixel data includes:
assigning the first event pixel data through (N/3)-th event pixel data among the first through N-th event pixel data to bits in the first red data of the first image pixel data;
assigning (N/3+1)-th event pixel data through (2N/3)-th event pixel data among the first through N-th event pixel data to bits in the first green data of the first image pixel data; and
assigning (2N/3+1)-th event pixel data through the N-th event pixel data among the first through N-th event pixel data to bits in the first blue data of the first image pixel data.

10. The method of claim 8, wherein the assigning the first through N-th event pixel data to the first through N-th bits in the first image pixel data includes:
assigning (3K−2)-th event pixel data among the first through N-th event pixel data to bits in the first red data of the first image pixel data, where K is a natural number greater than or equal to one and smaller than or equal to N/3;
assigning (3K−1)-th event pixel data among the first through N-th event pixel data to bits in the first green data of the first image pixel data; and
assigning 3K-th event pixel data among the first through N-th event pixel data to bits in the first blue data of the first image pixel data.

11. The method of claim 6, wherein:
the first event frame includes first through N-th event pixel data, the first through N-th event pixel data disposed at different locations in the first event frame, each of the first through N-th event pixel data including one-bit data;
the first image frame includes first image pixel data that includes N-bit data; and
the converting the first through N-th event frames into the first image frame includes assigning the first through N-th event pixel data to first through N-th bits in the first image pixel data.

12. The method of claim 11, wherein:
the plurality of event frames includes a second event frame;
the second event frame includes (N+1)-th through 2N-th event pixel data that are disposed at different locations in the second event frame, each of the (N+1)-th through 2N-th event pixel data includes one-bit data;
the first image frame further includes second image pixel data that includes N-bit data; and
the converting the first through N-th event frames into the first image frame further includes assigning the (N+1)-th through 2N-th event pixel data to first through N-th bits in the second image pixel data.

13. The method of claim 1, wherein:
the at least one image frame includes header information; and
the header information includes,
time information associated with the plurality of event frames, and
conversion scheme information indicating corresponding relationships between a plurality of event pixel data in the plurality of event frames and a plurality of image pixel data in the at least one image frame.

14. The method of claim 1, further comprising:
checking, using the at least one processor, a number of the plurality of event frames output from the dynamic vision sensor, and
wherein the converting the plurality of event frames into at least one image frame is performed based on the number of the plurality of event frames and a desired reference number.

15. The method of claim 1, further comprising:
checking, using the at least one processor, an operating time of the dynamic vision sensor, and
wherein the converting the plurality of event frames into at least one image frame is performed based on the operating time and a desired reference time.

16. The method of claim 1, further comprising:
storing, using the at least one processor, the compressed at least one image frame in a memory device.

17. A dynamic vision sensor comprising:
a pixel array including a plurality of pixels, the pixel array configured to detect changes of light to output a plurality of event frames; and
an image processor configured to,
convert the plurality of event frames into at least one image frame, and
compress the at least one image frame.

18. An electronic device comprising:
a dynamic vision sensor configured to detect changes of light, and output a plurality of event frames based on the detected changes of light; and at least one processor configured to
convert the plurality of event frames into at least one image frame, and
compress the at least one image frame.

19. The electronic device of claim 18, wherein the at least one processor is physically separate from the dynamic vision sensor.

20. The electronic device of claim 18, wherein the at least one processor is included in the dynamic vision sensor.
